(19) United States
(12) Patent Application Publication
(10) Pub. No.: US 2006/0143263 A1
(43) Pub. Date: Jun. 29, 2006

(54) Remote update apparatus, systems, and methods

(76) Inventors: Dinesh Kumar, Beaverton, OR (US); Carey W. Smith, Hillsboro, OR (US); Moshe Maor, Kiryat Mozkin (IL)

Correspondence Address: SCHWEGMAN, LUNDBERG, WOESSNER & KLUTH, P.A., P.O. BOX 2938, MINNEAPOLIS, MN, 55402, US

(21) Appl. No.: 11/027,770

(22) Filed: Dec. 29, 2004

(51) Int. Cl. G06F 15/16

(52) U.S. Cl. 709/201

(57) ABSTRACT

Apparatus and systems, as well as methods and articles, may operate to update an executable image associated with a network client basic input-output system (BIOS) from a remote network location during a time when a state of an operating system associated with the network client comprises one of active, inactive, accessible, inaccessible, present, corrupt, and missing.

### TECHNICAL FIELD

Various embodiments described herein relate to information processing generally, including apparatus, systems, and methods used in initializing a computer and in updating operational code.

### BACKGROUND INFORMATION

At power-on, or following a reset operation, a computer may execute an image associated with a basic input-output system (BIOS), including a series of programmed instructions that operate to load a set of basic device drivers. The drivers loaded by the BIOS may include, for example, display, keyboard, and mass storage drivers used to load an operating system (OS), and perhaps to perform diagnostic functions prior to loading the OS. Since the BIOS should be available for execution prior to loading the device drivers, the BIOS image may be stored in a non-volatile memory including, for example, a read-only memory (ROM), a programmable read-only memory (PROM), an electrically-erasable programmable read-only memory (EEPROM), or perhaps a flash memory device.

As hardware and operating system technology change, it may from time to time be desirable to upgrade the BIOS. Computer disassembly for integrated circuit replacement may be used to implement a BIOS image upgrade in the case of a ROM or PROM BIOS. A computer technician visit to install the new image may occur in the case of an EEPROM-based BIOS. Network administrators and other consumers may not see either option as a convenient course of action.

### BRIEF DESCRIPTION OF THE DRAWINGS

FIG. 1 is a block diagram of an apparatus and a system according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

Various embodiments disclosed herein may operate to permit upgrading an executable image from a remote location, including a BIOS image associated with a network client. Such action may obviate a human presence at the client location. Network controller technology associated with some computers may enable communications between the remote network location and the network client for the purpose of network management, including the performance of various diagnostics and update operations prior to initializing the OS, or when the OS is unavailable.

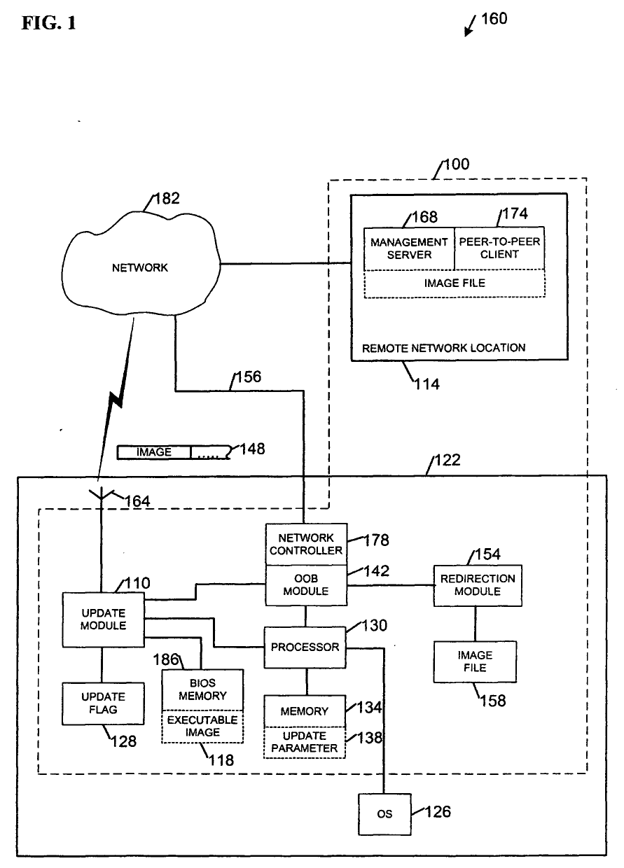

FIG. 1 comprises a block diagram of an apparatus 100 and a system 160 according to various embodiments of the invention. The apparatus 100 may include an update module 110 to communicate with a remote network location 114 to update an executable image 118, including perhaps a BIOS image associated with a network client 122. The executable image 118 may be updated during a time when an OS 126 associated with the network client 122 is in an active, inactive, accessible, inaccessible, present, corrupt, or missing state. The apparatus 100 may also include a BIOS update flag 128 to be set from the remote network location 114 to trigger the update module 110 to direct the network client 122 to re-initialize operation of the network client 122 in a BIOS update mode.

The apparatus 100 may further include a processor 130 coupled to the update module 110 to perform an update function, such as a BIOS update function, when the network client OS 126 is in an active, inactive, accessible, inaccessible, present, corrupt, or missing state. The apparatus 100 may also include a memory 134, including perhaps a non-volatile memory, coupled to the processor 130 to store one or more BIOS update parameters 138 associated with the BIOS update function. The non-volatile memory 134 may comprise a ROM, a PROM, an EEPROM, or perhaps a flash memory device.

Communication between the client 122 and the remote network location 114 during periods when the OS 126 is unavailable may be facilitated by an out-of-band (OOB) communications module 142 coupled to the update module 110 to intercept and respond to one or more BIOS update packets 148 received from the remote network location 114. The OOB communications module 142 may communicate using logical ports assigned for remote management communications, or may use a protocol different from that used by the OS 126. The apparatus 100 may include a redirection module 154 coupled to the out-of-band communication (OOB) module 142 to sense a connection 156 to the remote network location 114. The redirection module 154 may operate to initialize the network client 122 using an image file 158, such as an integrated device electronics (IDE) binary image file, received from the remote network location 114. Thus, in some embodiments, the operation of the network client 122 may be controlled by the remote network location 114, including switching on the client power supply to the processor 130 by remote control to prepare the client to receive an updated executable image 118. Other embodiments may be realized.

For example, a system 160 may include one or more of the apparatus 100 described above, as well as one or more update modules 110 to communicate with a remote network location 114. The remote network location 114 may include a network management server 168, and a peer-to-peer network client 174. The remote network location 114 may operate to update an executable image 118, including perhaps a BIOS image associated with a network client 122 during a time when an OS 126 associated with the network client 122 is in an active, inactive, accessible, inaccessible, present, corrupt, or missing state, as previously mentioned.

The system 160 may also include an antenna 164 (e.g., an omnidirectional antenna, patch antenna, or dipole antenna, among others) and a network controller 178 to couple to the update module 110 to provide physical-layer access to a network 182. The system 160 may further include a BIOS memory 186, including perhaps a non-volatile memory, coupled to the update module 110 to store the executable image 118.

The apparatus 100, update module 110, network location 114, executable image 118, network client 122, operating system (OS) 126, flag 128, processor 130, memory 134, update parameter 138, out-of-band (OOB) module 142, BIOS update packet 148, redirection module 154, connection 156, binary image file 158, system 160, antenna 164, network management server 168, peer-to-peer client 174, network controller 178, network 182, and BIOS memory 186 may all be characterized as “modules” herein.

Such modules may include hardware circuitry, single processor circuits, multi-processor circuits, memory circuits, software program modules and objects, firmware, and combinations thereof, as desired by the architect of the apparatus 100 and system 160, and as appropriate for particular implementations of various embodiments. Such modules may, for example, be included in a system operation simulation package, including a software electrical signal simulation package, a power usage and distribution simulation package, a capacitance-inductance simulation package, a power/heat dissipation simulation package, a signal transmission-reception simulation package, or a combination of software and hardware used to simulate the operation of various potential embodiments.

It should also be understood that the apparatus and systems of various embodiments can be used in applications other than updating a network client BIOS from a remote network location; and thus, various embodiments are not to be so limited. The illustrations of apparatus 100 and system 160 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single and multi-processor modules, single and multiple embedded processors, data switches, and application-specific modules, including multilayer, multi-chip modules. These apparatus and systems may further be included as sub-components within a variety of electronic systems, such as televisions, cellular telephones, personal computers, workstations, radios, video players, vehicles, and others. Some embodiments may include a number of methods.

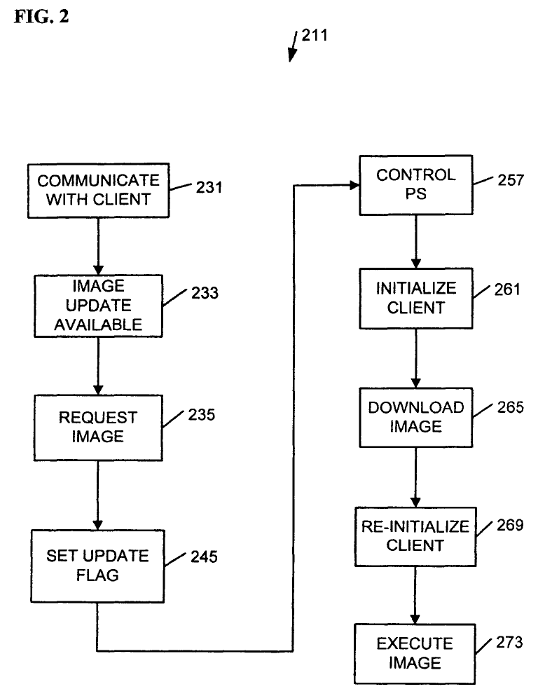

FIG. 2 is a flow diagram illustrating several methods 211 according to various embodiments of the invention. For example, a method 211 may begin at block 231 by communicating with the network client from the remote network location, perhaps using a network protocol stack not associated with the network client operating system. Messages associated with BIOS updating may, for example, be designed to occur “out-of-band” relative to a packet stream handled by the OS protocol stack, perhaps employing logical ports or protocols other than those typically used by the client OS. The method 211 may continue at block 233 with advising the client that a BIOS update is available, perhaps by communicating on a system management bus. The method 211 may include requesting the image from the remote network location, at block 235, and setting a flag in the network client from the remote network location to direct the client to initiate operation in a BIOS update mode, at block 245.

In some embodiments, method 211 may also include controlling a state of a network client power supply at block 257, and may further include initializing the network client by switching on the client power supply, perhaps to prepare the client to receive an updated BIOS image, at block 261. Method 211 may also include downloading the image to the network client, at block 265. Finally, method 211 may include re-initializing operation of the network client from the remote network location, at block 269, and executing the updated image obtained from the remote network location, at block 273. Thus, it can be understood that in some embodiments, the method 211 may include updating an executable image, perhaps comprising a BIOS image associated with a network client, from a remote network location during a time when an operating system associated with the network client is in an active, inactive, accessible, inaccessible, present, corrupt, or missing state.

It should be noted that the methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment. Thus, other embodiments may be realized.

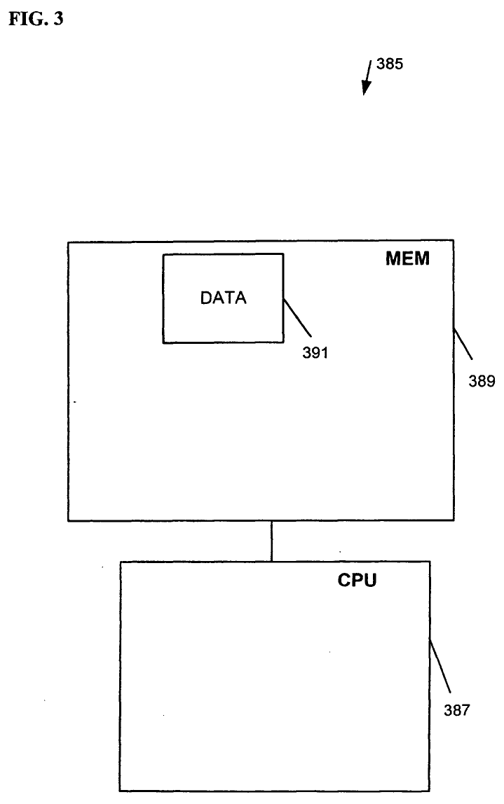

For example, FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processors 387 coupled to a machine-accessible medium such as a memory 389 (e.g., a memory including an electrical, optical, or electromagnetic conductor) having associated information 391 (e.g., computer program instructions, data, or both) which, when accessed, results in a machine (e.g., the processors 387) performing such actions as communicating the availability of a BIOS update to the network client, possibly on the system management bus.

Other activities may include updating an executable image, including perhaps a BIOS image associated with a network client, from a remote network location during a time when an operating system associated with the network client is in an active, inactive, accessible, inaccessible, present, corrupt, or missing state, as previously described.

Implementing the apparatus, systems, and methods disclosed herein may operate to permit updating an executable image associated with a network client BIOS from a remote network location, irrespective of the state of the client operating system. Performing such upgrades remotely may decrease costs and increase convenience associated with network client maintenance.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, including:
updating an executable image associated with a network client basic input-output system (BIOS) from a remote network location during a time when a state of an operating system associated with a network client comprises one of active, inactive, accessible, inaccessible, present, corrupt, and missing.

2. The method of claim 1, further including:
setting a flag in the network client from the remote network location to direct the network client to initiate operation in a BIOS update mode.

3. The method of claim 1, further including:
requesting the image from the remote network location.

4. The method of claim 1, further including:
downloading the image to the network client.

5. The method of claim 1, further including:
re-initializing operation of the network client from the remote network location.

6. The method of claim 5, wherein re-initializing the operation of the network client further includes:
executing an updated image obtained from the remote network location.

7. The method of claim 1, further including:
communicating with the network client from the remote network location using a network protocol stack not associated with the operating system.

8. The method of claim 1, further including:
controlling a state of a network client power supply.

9. The method of claim 8, further including:
initializing the network client by switching on the client power supply to prepare the client to receive an updated BIOS image.

10. An article including a machine-accessible medium having associated information, wherein the information, when accessed, results in a machine performing:
updating an executable image associated with a network client basic input-output system (BIOS) from a remote network location during a time when a state of an operating system associated with a network client comprises one of active, inactive, accessible, inaccessible, present, corrupt, and missing.

11. The article of claim 10, further including:
communicating an availability of a BIOS update to the network client.

12. The article of claim 11, wherein the availability is communicated on a system management bus associated with the network client.

13. An apparatus, including:
an update module to communicate with a remote network location to update an executable image associated with a network client basic input-output system (BIOS) during a time when a state of an operating system associated with a network client comprises one of active, inactive, accessible, inaccessible, present, corrupt, and missing.

14. The apparatus of claim 13, further including:
a processor coupled to the update module to perform at least one BIOS update function during the time when the state of the network client operating system comprises one of active, inactive, accessible, inaccessible, present, corrupt, and missing.

15. The apparatus of claim 14, further including:
a memory coupled to the processor to store at least one BIOS update parameter associated with the at least one BIOS update function.

16. The apparatus of claim 15, wherein the memory comprises a non-volatile memory.

17. The apparatus of claim 13, further including:
a BIOS update flag to be set from the remote network location and to couple to the update module to direct the network client to re-initialize operation in a BIOS update mode.

18. The apparatus of claim 13, further including:
an out-of-band communications module coupled to the update module to intercept and respond to at least one BIOS update packet received from the remote network location.

19. The apparatus of claim 18, further including:
a redirection module coupled to the out-of-band communications module to sense a connection to the remote network location and to initialize operation of the network client using an integrated device electronics (IDE) binary image file received from the remote network location.

20. A system, including:
an omnidirectional antenna; and
an update module to communicate with a remote network location to update an executable image associated with a network client basic input-output system (BIOS) during a time when a state of an operating system associated with a network client comprises one of active, inactive, accessible, inaccessible, present, corrupt, and missing.

21. The system of claim 20, wherein the remote network location comprises a network client management server.

22. The system of claim 20, wherein the remote network location comprises a peer-to-peer network client.

23. The system of claim 20, further including:
a network controller to couple to the update module to provide physical-layer access to a network.

24. The system of claim 20, further including:
a non-volatile memory coupled to the update module to store the executable image.
